(19) United States
(12) Patent Application Publication
(10) Pub. No.: US 2010/0315175 A1
(43) Pub. Date: Dec. 16, 2010

(54) Marchand balun

(75) Inventors: Naoko Ono, Bunkyo-ku (JP); Toshiya Mitomo, Kawagoe-shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/807,160

(22) Filed: Mar. 6, 2009

(30) Foreign Application Priority Data
Mar. 31, 2008 (JP) 2008-093932

(51) Int. Cl. H01P 5/10

(52) U.S. Cl. 333/26

(57) ABSTRACT

According to an aspect of the present invention, there is provided a Marchand balun including: a half-wavelength first line including: a first end configured to input or output the single-mode signal; a second end electrically opened; and a center; and quarter-wavelength second and third lines each including: a third end configured to input or output the differential-mode signal; and a fourth end connected to a ground, wherein a thickness of the first line at the center is thicker than those at the first and second ends, and wherein thicknesses of the second and third lines at the fourth ends are thicker than those at the third ends.

### CROSS-REFERENCE TO RELATED APPLICATIONS

This application claims priority from Japanese Patent Application No. 2008-093932 filed on Mar. 31, 2008, the entire contents of which are incorporated herein by reference.

### BACKGROUND OF THE INVENTION

1. Field of the Invention

An aspect of the present invention relates to a Marchand balun.

2. Description of the Related Art

Generally, in a high-frequency circuit, a single-mode circuit for processing a single-mode signal, and a differential-mode circuit for processing a differential-mode signal are used together. A balun is used as a conversion device for converting a single-mode signal into a differential-mode signal or for converting a differential-mode signal into a single-mode signal.

As a balun, a Marchand balun is known (see, e.g., JP-2000-183601-A). The Marchand balun is a balun that uses an electromagnetic coupling. As compared with other kinds of the balun, the Marchand balun is featured in that the configuration thereof is simple, and that the passage loss of the conversion device is low. Thus, it is expected to apply the Marchand balun to high-frequency circuits.

The Marchand balun is configured by use of a lines having a length equal to one half of a wavelength corresponding to an operating frequency and lines having a length equal to one quarter of the wavelength corresponding to the operating frequency. Each line is formed of a wiring metal.

Especially in the high-frequency circuit, the electric loss generated in the line when the current flows through the wiring metal is non-negligible, and the passage loss in the Marchand balun is increased.

### SUMMARY OF THE INVENTION

According to an aspect of the present invention, there is provided a Marchand balun for converting a single-mode signal into a differential-mode signal or for converting the differential-mode signal into the single-mode signal, the Marchand balun including: a first line including: a first end portion configured to input or output the single-mode signal; a second end portion electrically opened; and a central portion, the first line having a length substantially equal to one half of a wavelength corresponding to an operating frequency; and a second line and a third line each including: a third end portion configured to input or output the differential-mode signal; and a fourth end portion connected to a ground, the second and third lines each having a length substantially equal to one quarter of the wavelength corresponding to the operating frequency, wherein the second and third lines are arranged to be substantially parallel to the first line and are arranged so that the third end portions are closely faces via a gap, wherein a thickness of the first line at the central portion is thicker than those at the first and second end portions, and wherein thicknesses of the second and third lines at the fourth end portions are thicker than those at the third end portions.

### BRIEF DESCRIPTION OF THE DRAWINGS

FIG. 1 is a circuit diagram showing a Marchand balun according to Embodiment 1 of the invention;

FIGS. 2A to 2C are diagrams showing the configuration of the Marchand balun;

FIG. 3 is a table showing simulation results for the Marchand balun;

FIGS. 4A to 4C are diagrams showing the configuration of a Marchand balun according to Embodiment 2 of the invention;

FIGS. 5A to 5C are diagrams showing the configuration of a Marchand balun according to Embodiment 3 of the invention;

FIGS. 6A to 6C are diagrams showing the configuration of a Marchand balun according to Embodiment 4 of the invention;

FIGS. 7A to 7C are diagrams showing the configuration of a Marchand balun according to Embodiment 5 of the invention;

FIGS. 8A to 8E are diagrams showing the configuration of a Marchand balun according to Embodiment 6 of the invention; and

FIGS. 9A to 9E are diagrams showing the configuration of the Marchand balun according to Embodiment 6.

### DETAILED DESCRIPTION OF THE INVENTION

Hereinafter, embodiments of the invention are described with reference to the accompanying drawings.

### Embodiment 1

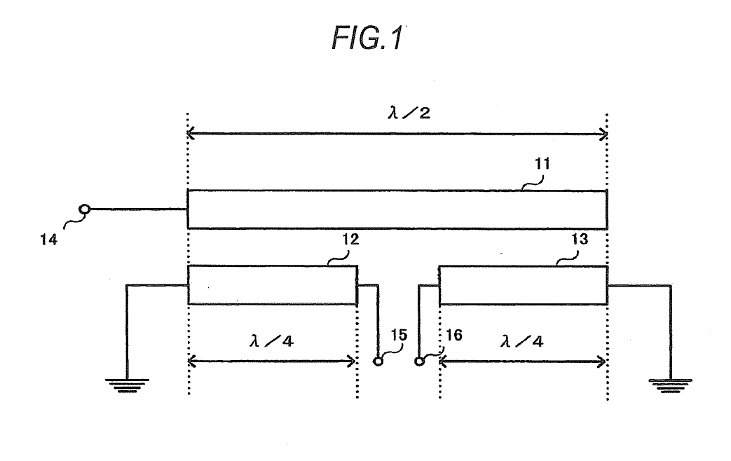

FIG. 1 is a circuit diagram illustrating a Marchand balun according to Embodiment 1 of the invention. In the following description of the present embodiment, a Marchand balun for converting a single-mode signal into a differential-mode signal is described. However, when an input end and an output end are interchanged, the Marchand balun can convert a differential-mode signal into a single-mode signal.

The Marchand balun includes a first line 11 having a length that is one half of a wavelength corresponding to an operating frequency, a second line 12 and a third line 13 each having a length that is one quarter of the wavelength corresponding to the operating frequency, an input terminal 14 connected to one end of the first line 11, an output terminal 15 connected to one end of the second line 12, and an output terminal 16 connected to one end of the third line 13. The output terminals 15 and 16 operate in pair as differential output terminals.

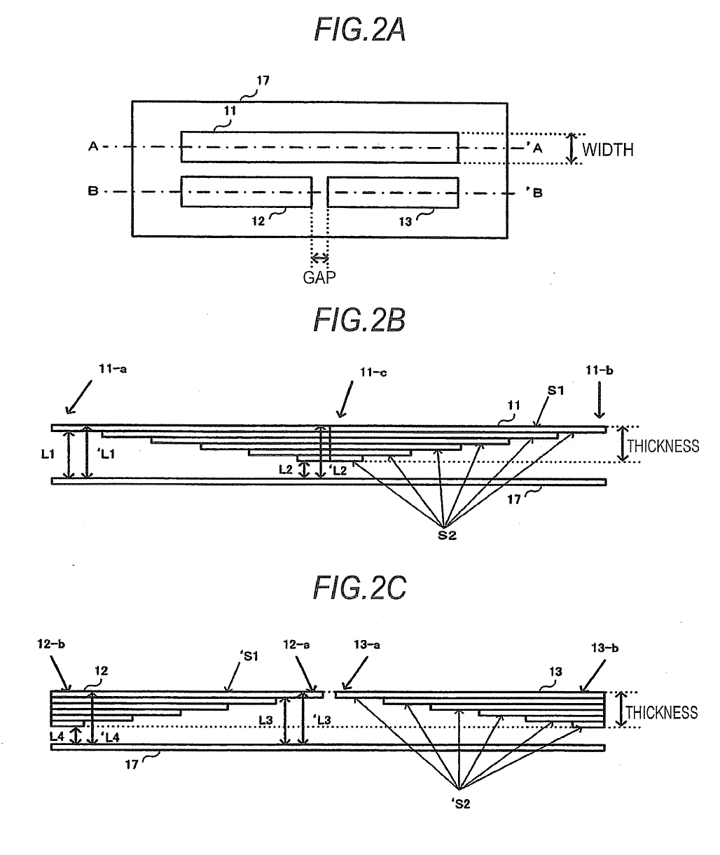

Each of the lines 11, 12, and 13 is described in detail below with reference to FIGS. 2A and 2B. FIG. 2A is a top diagram of the Marchand balun according to the present embodiment, which is taken from a line-stacking direction. The “line-stacking direction” designates a direction in which the lines (line members) are stacked, and means a direction substantially perpendicular to the ground plane of a micros trip line. The input terminal 14 and the output terminals 15 and 16 are omitted in FIG. 2A.

FIGS. 2A and 2B are the top diagram and a cross-sectional diagram of the first line 11, respectively. FIG. 2B is a cross-sectional diagram of the Marchand balun, which is taken along line A-′A shown in FIG. 2A.

The first line 11 is formed of a wiring metal. The first line 11 has a width of several to several ten micrometers (μm) and a thickness of several μm. The length of the first line 11 is about one half the wavelength corresponding to an operating frequency. The operating frequency designates the frequency of a single-mode signal and/or a differential-mode signal that can be converted by the Marchand balun according to the present embodiment. More specifically, the operating frequency designates the frequency of a single-mode signal input to the input terminal 14.

The first line 11 is provided substantially in parallel to a ground 17. The first line 11 has a surface S1 that is most distant from the ground 17, and a surface S2 opposed to the ground 17. When the first line 11 has a structure, in which a plurality of line-members are stacked, as will be described below, the surface S1 is a surface of one (more specifically, the longest one) of the plurality of line-members, which is most distant from the ground 17, and is not contacted with the other line-members. The surface S2 includes a part of an associated one of surfaces of the plurality of the stacked line-members, which is contacted with an adjacent one of the plurality of the stacked line-members, so that the part thereof is not hidden by the other line-members of the plurality of the stacked line-members. One end 11-a is connected to the input terminal 14 (not shown in FIGS. 2A to 2C). The other end 11-b is open.

The first line 11 is not uniform in thickness. A center 11-c of the first line 11 is thicker than ends 11-a and 11-b thereof. That is, the distance L2 from the surface S2 at the center 11-b to the ground 17 is shorter than the distance L1 from the surface S2 at the one end 11-a to the ground 17 (L1>L2).

On the other hand, the distance ′L1 from the surface S1 at the one end 11-a to the ground 17 is nearly equal to the distance ′L2 from the surface S1 at the center 11-c to the ground 17 (′L1≈′L2). This can be implemented by, e.g., stacking a plurality of line-members in a thickness direction (i.e., a stacking direction) from the ground 17 in the ascending order of length, as illustrated in FIG. 2B. Thus, the first line 11 has a tapered structure obtained by stacking a plurality of line-members in this manner, in which the thickness of the first line 11 is maximum at the center 11-c thereof.

FIGS. 2A and 2C are a top diagram and a cross-sectional diagram illustrating the second line 12 and the third line 13, respectively. FIG. 2C is the cross-sectional diagram of the Marchand balun, which is taken along line B-′B shown in FIG. 2A.

Each of the second line 12 and the third line 13 is formed of a wiring metal. Each of the second line 12 and the third line 13 has a width of several to several tens μm and a thickness of several μm. The length of each of the second line 12 and the third line 13 is about one quarter of the wavelength corresponding to the operating frequency.

As viewed from above, the second line 12 and the third line 13 are provided substantially in parallel to the ground 17 and the first line 11. In addition, as viewed from above, the second line 12 and the third line 13 are provided to extend on the same line. Each of the second line 12 and the third line 13 has a surface ′S1, which is most distant from the ground 17, and a surface ′S2 opposed to the ground 17. When each of the second line 12 and the third line 13 has a structure, in which a plurality of line-members are stacked, as will be described below, the surface ′S1 is a surface of one (more specifically, the longest one) of the plurality of line-members, which is most distant from the ground 17, and is not contacted with the other line-members. The surface ′S2 includes a part of an associated one of surfaces of the plurality of the stacked line-members, which is contacted with an adjacent one of the plurality of the stacked line-members, so that the part thereof is not hidden by the other line-members of the plurality of the stacked line-members.

One end 12-a of the second line 12 and one end 13-a of the third line 13 are connected to output terminals 15 and 16 (not shown in FIGS. 2A to 2C), respectively. The one end 12-a of the second line 12 and the one end 13-a of the third line 13 are closely arranged through a gap. The gap has a width of about several tenths μm to several tens μm. The other end 12-b of the second line 12 and that 13-b of the third line 13 are connected to the ground 17 (not shown in FIGS. 2A to 2C). For example, vias are formed in the vicinity of the other ends 12-b and 13-b, and the second line 12 and the third line 13 are short-circuited with the ground 17, respectively.

In the second line 12, the thickness is not uniform, and the other end 12-b is thicker than the one end 12-a. That is, the distance L4 between the surface ′S2 at the other end 12-b and the ground 17 is shorter than the distance L3 between surface ′S2 at the one end 12-a and the ground 17 (L3>L4). On the other hand, the distance ′L3 from the surface ′S1 at the one end 12-a to the ground 17 is nearly equal to the distance ′L4 from the surface ′S1 at the other end 12-b to the ground 17 (′L3≈′L4). This can be implemented by, e.g., stacking a plurality of line-members in a thickness direction (i.e., a stacking direction) from the ground 17 in the ascending order of length, as illustrated in FIG. 2C. Thus, the second line 12 has a tapered structure obtained by stacking a plurality of line-members in this manner, in which the thickness of the second line 12 is maximum at the other end 12-b thereof.

The third line 13 has a structure similar to that of the second line 12. The third line 13 has a tapered structure in which the thickness of the third line 13 is maximum at the other end 13-b thereof.

Next, an operating principle of the Marchand balun according to the present embodiment is described below. The Marchand balun illustrated in FIG. 1 converts a single-mode signal, which is input from the input terminal 14, into a differential-mode signal and outputs the differential-mode signal from the output terminals 15 and 16.

A single-mode signal input from the input terminal 14 flows from the first line 11 to the second line 12 and the third line 13 due to electromagnetic coupling. The second line 12 and the third line 13 are arranged such that the phase of current flowing through the second line 12 is opposite to the phase of current flowing through the third line 13. Thus, the single-mode signal is converted into a differential-mode signal. The converted differential-mode signal is output from the output terminals 15 and 16. The phases of the signals respectively flowing through the second line 12 and the third line 13 are opposite to each other for the following reason. That is, the degree of the proximity between the one ends 12-a and 13-a, to which the output terminals 15 and 16 are respectively connected, is higher than that of the proximity between the other ends 12-b and 13-b each of which is connected to the ground 17. More specifically, the second line 12 and the third line 13 are arranged through the gap symmetrically with respect thereto. Consequently, the phases of signals respectively flowing through the second line 12 and the third line 13 are opposite to each other.

Hereinafter, the principle for reducing the passage loss of the Marchand balun according to the present embodiment is described.

Although currents flow through the first line 11, the second line 12, and the third line 13, respectively, a current distribution in each of the lines 11, 12, and 13 is not uniform. The first line 11 is a one-half wavelength line, in which the other end 11-b thereof is opened. Accordingly, a current is hardly flows in the both ends 11-a and 11-b. The magnitude of current flowing in the first line 11 is gradually increased towards the center 11-c.

When the thickness of the line is uniform, the larger the current flows therethrough, the larger the unnecessary electric loss increases. Consequently, an electric loss in the whole line increases. The electric loss changes according to the magnitude of current flowing therethrough. The current at the center 11-c is large, while the currents at each of the ends 11-a and 11-b are small. Then, the first line 11 is formed so that the thickness gradually increases towards the center 11-c at which a large current flows, and that the thickness gradually decreases towards each of ends 11-a and 11-b at each of which current is hard to flow. When the current value is constant, the loss changes according to the cross-sectional area of the line. The larger the cross-sectional area of the line becomes, the smaller the loss does. The unnecessary loss caused in the first line 11 is suppressed by changing the thickness of the line such that the cross-sectional area of the line gradually increases towards the center 11-c in which a large current flows.

The second line 12 is a line, the other end of which is short-circuited, and has a length equal to one quarter of the wavelength corresponding to the operating frequency. Accordingly, large current flows in the other end 12-b, while current is hard to flow in the one end 12-a. Similarly to the first line 11, when the thickness of the line is uniform, unnecessary loss is caused. Thus, the second line is formed so that the thickness gradually increases towards the other end 12-b, in which large current flows, from the thickness of the one end 12-a. Consequently, unnecessary loss caused in the second line 12 is suppressed. The principle applied to the third line 13 is similar to that applied to the second line 12. Therefore, the detail description thereof is omitted.

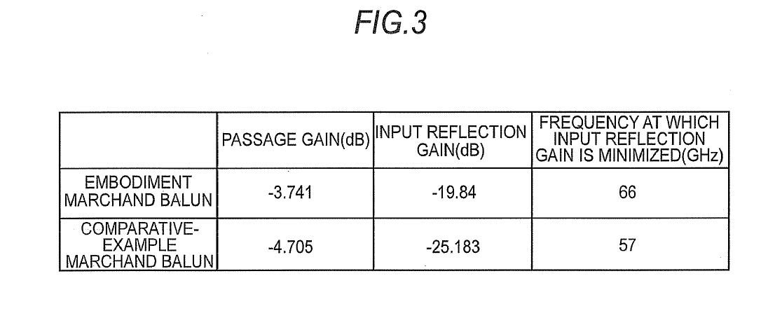

A simulation result for characteristic comparison between the Marchand balun according to the present embodiment and the Marchand balun according to the comparison example, in which the thickness of the line is uniform, is described below with reference to FIG. 3.

In the embodiment Marchand balun, the line-members are stacked as three layers, the thickness of each of which is changed. The first line 11 is obtained by stacking a line-member having a length of 400 μm, a line-member having a length of 800 μm, and a line-member having a length of 1200 μm arranged in this order from the side of the ground. In each of the second line 12 and the third line 13, a line-member having a length of 200 μm, a line-member having a length of 400 μm, and a line-member having a length of 600 μm are stacked in this order from the side of the ground. The rest of the embodiment Marchand balun is similar to that of the Marchand balun illustrated in FIGS. 1 to 2C.

In the comparative-example Marchand balun using the uniform-thickness lines, each line is obtained by stacking only one single layer. The rest of the comparative-example Marchand balun is similar to that of the Marchand balun illustrated in FIG. 1. The simulation is performed by setting the length of the first line of the comparative-example Marchand balun at 1200 μm and setting the length of each of the second line and the third line thereof at 600 μm.

FIG. 3 illustrates a simulation result using the aforementioned parameters. In the simulation, the characteristic impedance of the first line is set at 50 ohms (Ω). The differential characteristic impedance of the second line and the third line is set at 100Ω.

As illustrated in FIG. 3, the passage gain of the embodiment Marchand balun is −3.741 dB. The passage gain of the comparative-example Marchand balun is −4.750 dB. The passage gain means the signal flowability of the Marchand balun when a signal flows from the input terminal to the output terminal. The larger the passage gain is, the smaller the passage loss becomes, so that the smaller the electric power loss of the signal becomes when the signal input to the input terminal is output from the output terminal.

The passage gain of the embodiment Marchand balun is smaller than that of the comparative-example Marchand balun by about 1 dB. Thus, it is found that the embodiment Marchand balun is smaller in passage loss than the comparative-example Marchand balun.

Further, a frequency, at which an input reflection gain is minimized, of the embodiment Marchand balun is 66 GHz. Such a frequency of the comparative-example Marchand balun is 57 GHz. These frequencies correspond to operating frequencies of the embodiment Marchand balun and the comparative-example Marchand balun, at which the associated Marchand balun is operated in the simulation. The minimum input reflection gain of the embodiment Marchand balun is −19.84 dB. The minimum input reflection gain of the comparative-example Marchand balun is −25.183 dB. Generally, when the input reflection gain of a circuit is about −10 dB, this circuit can sufficiently be used as a high frequency circuit.

As described above, according to Embodiment 1, unnecessary loss caused in the line is suppressed by changing the thickness of the line. Thus, a Marchand balun of the low passage loss can be implemented.

Here, the characteristic impedance of the Marchand balun is determined based on the width of each line and the distance from each line to the ground. Since each of the lines is constructed by stacking a plurality of line-members to provide a tapered structure, the line width and the line-to-ground there of can be precisely adjusted, and the characteristic impedance can be set so that the operation of the Marchand balun is ensured.

Further, since the tapered structure of the line is constructed by stacking a plurality of line-members, the lines can be easily mounted. Although the step-like tapered structure is illustrated in the aforementioned description, the unnecessary loss in the line can be also suppressed when the line is provided with the gently tapered structure.

When the Marchand balun is fabricated by semiconductor process, the plurality of line-members are formed by use of the wiring metal layers available in the process. In this case, insulating layers are provided between the plurality of line-members, and the plurality of line-members are connected with each other by vias.

### Embodiment 2

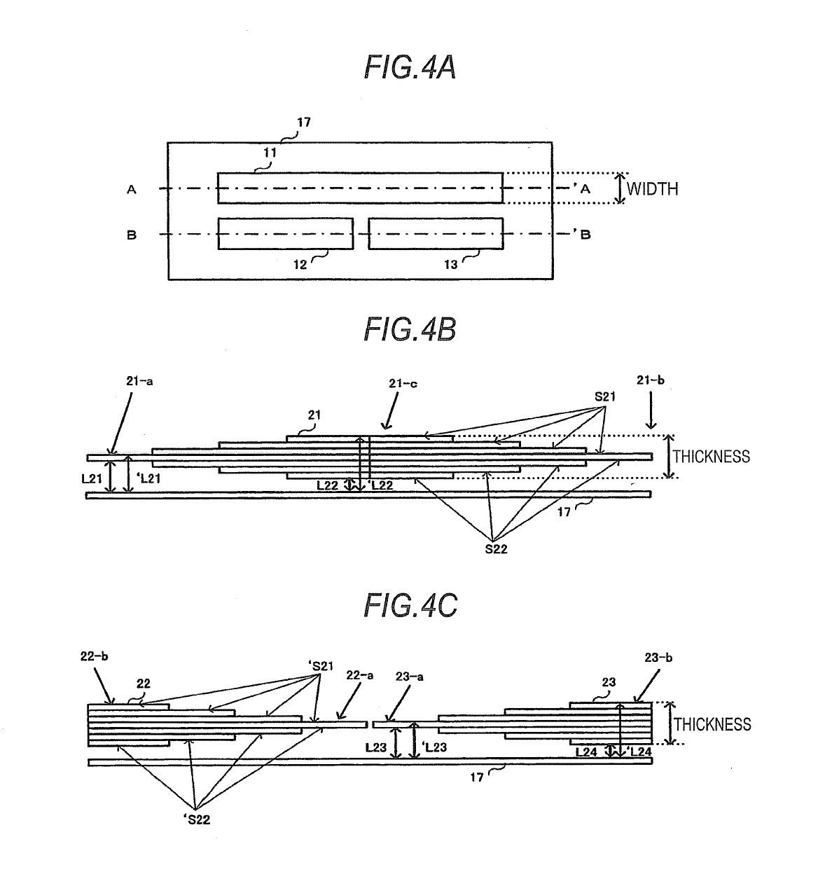

A Marchand balun according to Embodiment 2 is described hereinafter with reference to FIGS. 4A to 4C. The Marchand balun according to Embodiment 2 employs the same configuration and the same operating principle as those of the Marchand balun according to Embodiment 1, except for the thickness of each of the lines. Thus, components of Embodiment 2, which are the same as those of Embodiment 1, are designated with the same reference numerals as those denoting the same components of Embodiment 1. Consequently, the description of such components is omitted.

A first line 21 has the surface S21, which is most distant from the ground 17 at an associated lateral position, as viewed in FIG. 4B, and a surface S22 opposed to the ground 17. When the first line 21 has a structure obtained by stacking a plurality of line-members, as will be described below, the surface S21 and the surface S22 include a part that is contacted with an associated one of the other ones of the plurality of stacked line-members and that is not hidden by the other line-members.

The first line 21 is similar to the first line 11 according to Embodiment 1 in that the thickness thereof is not uniform, and that a center 21-c is thicker than ends 21-a and 21-b. However, the distance between the ground 17 and the surface S21 of the first line 21 changes, while the distance between the ground 17 and the surface S1 of the first line 11, which is most distant from the ground 17, is substantially constant.

That is, as viewed in FIG. 4B, the distance ′L21 between the surface S21 at the one end 21-a and the ground 17 is shorter than the distance ′L22 between the surface S21 at the center 21-c and the ground 17 (′L21<′L22).

This can be implemented by, e.g., stacking a plurality of line-members of different length, as illustrated in FIG. 2A. At that time, gradually shorter line-members are sequentially stacked after a plurality of different-length line-members are stacked in the ascending order of the length from the side of the ground 17 so that gradually longer line-members are sequentially stacked. Consequently, a structure, in which the center 21-c is thickest, can be provided in the first line 21 by stacking the plurality of line-members in this manner.

Each of the second line 22 and the third line 23 has a surface ′S21, which is most distant from the ground 17 at an associated lateral position, as viewed in FIG. 4C, and a surface ′S22 opposed to the ground 17. When each of the second line 22 and the third line 23 has a structure in which a plurality of line-members are stacked, as will be described below, the surface ′S21 and the surface ′S22 include a part that is contacted with an associated one of the other ones of the plurality of stacked line-members and that is not hidden by the other line-members.

The second line 22 is similar to the second line 12 according to Embodiment 1 in which the thickness thereof is not uniform, and that as compared with one end 22-a, the other end 22-b is thicker. However, the distance between the ground 17 and the surface ′S21 of the second line 22 changes, while the distance between the ground 17 and the surface ′S1 is substantially constant in Embodiment 1.

That is, as viewed in FIG. 4C, the distance ′L23 between the surface ′S21 at the one end 22-a and the ground 17 is shorter than the distance ′L24 between the surface ′S21 at the center 22-c and the ground 17 (′L23<′L24). This can be implemented by, e.g., stacking a plurality of line-members differing in length from one another, as illustrated in FIG. 2B. At that time, gradually shorter line-members are sequentially stacked after gradually longer line-members are sequentially stacked by stacking a plurality of line-members in the ascending order of the length from the side of the ground 17. Consequently, a structure, in which the center 22-c is thickest, can be provided in the second line 22 by stacking the plurality of line-members in this manner. The third line 23 has a thickness obtained similarly to the second line 22. Thus, the description of the third line 23 is omitted.

As described above, according to Embodiment 2, unnecessary loss caused in the line is suppressed by changing the thickness of the line. Thus, a Marchand balun of the low passage loss can be implemented.

Since each of the lines of the Marchand balun is constructed by stacking a plurality of line-members differing in length from one another to provide a tapered structure in the line, the characteristic impedance of the Marchand balun can be suitably adjusted.

### Embodiment 3

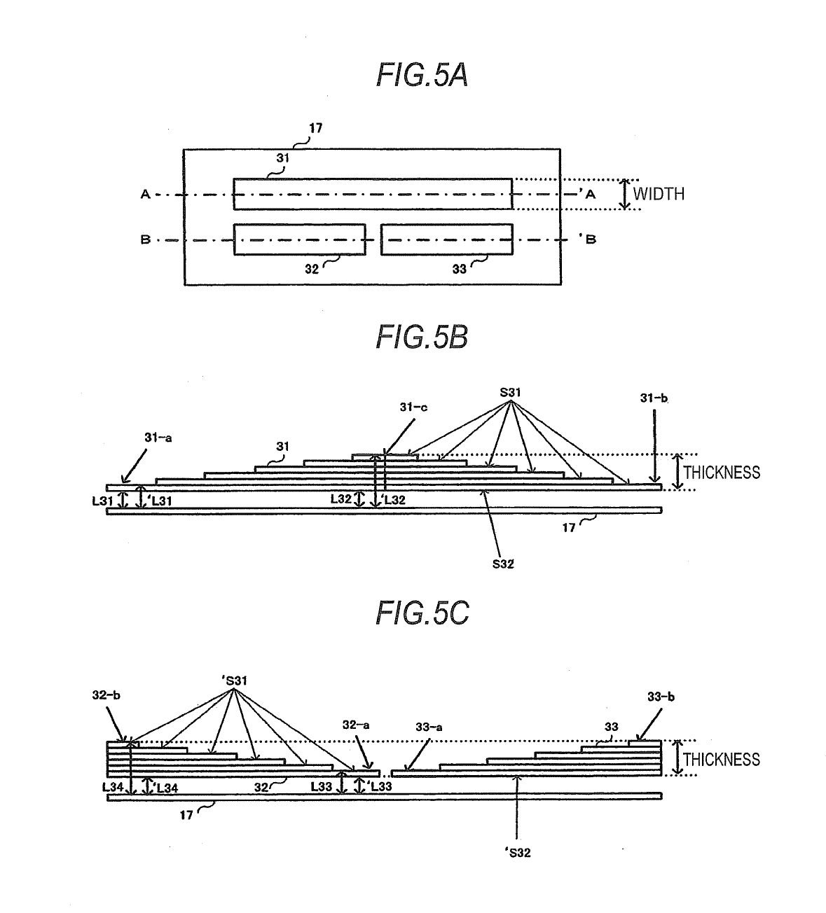

A Marchand balun according to Embodiment 3 is described hereinafter with reference to FIGS. 5A to 5C. The Marchand balun according to Embodiment 3 employs the same configuration and the same operating principle as those of the Marchand balun according to Embodiment 1, except for the thickness of each of the lines. Thus, components of Embodiment 3, which are the same as those of Embodiment 1, are designated with the same reference numerals as those denoting the same components of Embodiment 1. Consequently, the description of such components is omitted.

A first line 31 has a surface S31, which is most distant from the ground 17 at an associated lateral position, as viewed in FIG. 5B, and a surface S32 opposed to the ground 17. When the first line 31 has a structure obtained by stacking a plurality of line-members, as will be described below, the surface S31 includes a part that is contacted with an associated one of the other ones of the plurality of stacked line-members and that is not hidden by the other line-members. The surface 32 is a surface of the line-member (i.e., the longest line-member) that is closest, to the ground and is not contacted with the other line-members.

The first line 31 is similar to the first line 11 according to Embodiment 1 in that the thickness thereof is not uniform, and that a center 31-c is thicker than ends 31-a and 31-b. However, the distance between the ground 17 and the surface S32 of the first line 31 is substantially constant, while the distance between the ground 17 and the surface S1 of the first line 11 is substantially constant in Embodiment 1. That is, as viewed in FIG. 5B, the distance ′L31 between the surface S31 at the one end 31-a and the ground 17 is shorter than the distance ′L32 between the surface S31 at the center 31-c and the ground 17 (′L31<′L32).

On the other hand, the distance L31 from the surface S32 at the one end 31-a to the ground 17 is nearly equal to the distance L32 from the surface S32 at the center 31-c to the ground 17 (L31≈L32). This can be implemented by, e.g., stacking a plurality of line-members in a thickness direction in the descending order of length, as illustrated in FIG. 5B. Thus, the first line 31 has a tapered structure obtained by stacking a plurality of line-members in this manner, in which the thickness of the first line 31 is maximum at the center 31-c thereof.

Each of the second line 32 and the third line 33 has the surface ′S31, which is most distant from the ground 17 at an associated lateral position, as viewed in FIG. 50, and a surface ′S32 opposed to the ground 17. When each of the second line 32 and the third line 33 has a structure in which a plurality of line-members are stacked, as will be described below, the surface ′S31 includes a part that is contacted with an associated one of the other ones of the plurality of stacked line-members and that is not hidden by the other line-members. The surface ′S32 is a surface of the line (i.e., the longest line-member), which is closest to the ground, and is not contacted with the other line-members.

The second line 32 is similar to the first line 11 according to Embodiment 1 in that the thickness thereof is not uniform, and that as compared with one end 32-a, the other end 32-b is thicker. However, the distance between the ground 17 and the surface ′S32 of the second line 32 is substantially constant, while the distance between the ground 17 and the surface ′S1 of the first line 11 in Embodiment 1.

That is, the distance L33 between the surface ′S31 at the one end 32-a and the ground 17 is shorter than the distance L34 between the surface ′S31 at the other end 32-b and the ground (L33<L34).

On the other hand, the distance ′L33 from the surface ′S32 at the one end 32-a to the ground 17 is nearly equal to the distance ′L34 from the surface ′S32 at the other end 32-b to the ground 17 (′L33 ′L34). This can be implemented by, e.g., stacking a plurality of line-members in a thickness direction in the descending order of length, as illustrated in FIG. 5C. Thus, the first line 31 has a tapered structure obtained by stacking a plurality of line-members in this manner, in which the thickness of the second line 32 is maximum at the other end 32-b thereof. The third line 33 has a thickness obtained similarly to the second line 32. Thus, the description of the third line 33 is omitted.

As described above, according to Embodiment 3, unnecessary loss caused in the line is suppressed by changing the thickness of the line. Thus, a Marchand balun of the low passage loss can be implemented.

Since each of the lines of the Marchand balun is constructed by stacking a plurality of line-members differing in length from one another to provide a tapered structure in the line, the characteristic impedance of the Marchand balun can be suitably adjusted.

As described above, the characteristic impedance of the Marchand balun is determined based on the width of each line and the distance from each line to the ground. By increasing the line-to-ground distance, the characteristic impedance can be increased.

According to the present embodiment, since the distance between the ground 17 and the line can be maintained at a constant value by setting the length of the line closest to the ground 17 to be longest, the characteristic impedance of the line can be set to a value substantially similar to that of the comparative-example Marchand balun having the lines of uniform thickness.

### Embodiment 4

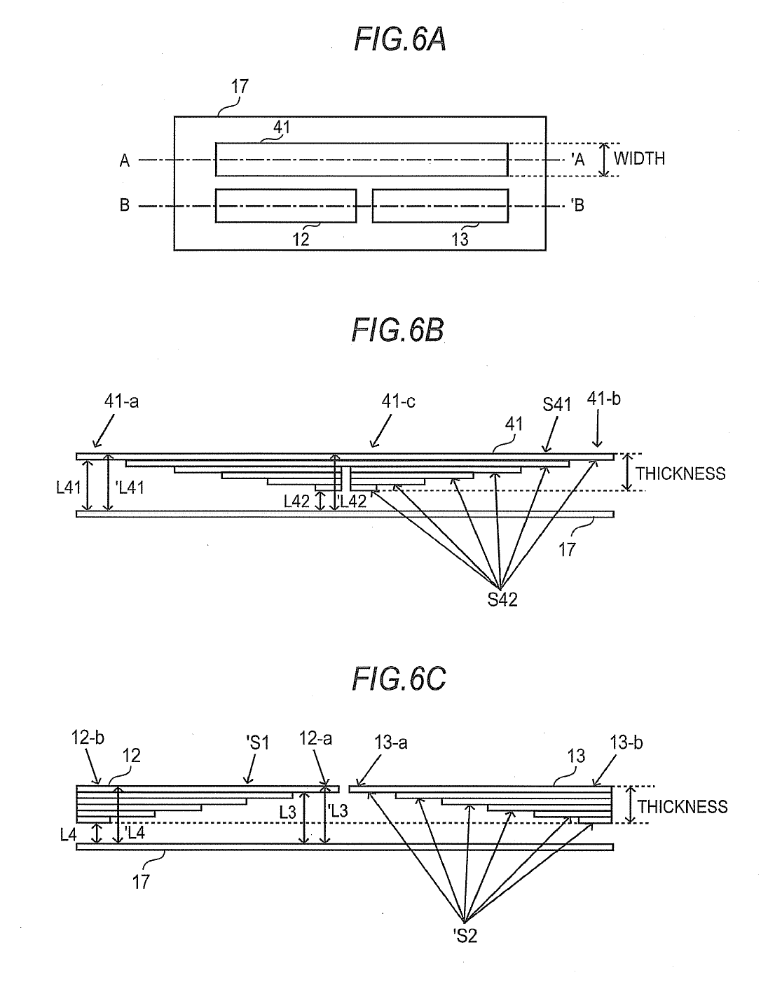

A Marchand balun according to Embodiment 4 is described hereinafter with reference to FIGS. 6A to 6C. Although each of the Marchand baluns according to the first to third embodiments is configured so that the thickness of each of the lines increases towards the center or the other end, the Marchand balun according to Embodiment 4 in which the line includes a portion deviated from the thickness trend in the tapered structure. As described above, unnecessary loss is caused in a part in which large current flows. Thus, it is advisable to increase the cross-sectional area of the line only at such a part.

For example, according to the present embodiment, a tapered structure is provided at each part at which electromagnetic coupling among a first line 41, a second line 12, and a third line 13 is strong. However, the thickness of a center, in which electromagnetic coupling is weak, is reduced. The center 41-c is a part that includes a central thin portion and a central thickest portion.

The Marchand balun according to Embodiment 4 employs the same configuration and the same operating principle as those of the Marchand balun according to Embodiment 1, except for the aforementioned respects. Thus, components of Embodiment 4, which are the same as those of Embodiment 1, are designated with the same reference numerals as those denoting the same components of Embodiment 1. Consequently, the description of such components is omitted.

As described above, according to Embodiment 4, unnecessary loss caused in the line is suppressed by changing the thickness of the line. Thus, a Marchand balun of the low passage loss can be implemented. The thickness of the line is not necessarily set so that the thickness is gradually increased towards a center or towards the other end. According to the present embodiment, the thickness of a part, in which electromagnetic coupling is weak, can be reduced. Alternatively, the thickness of a part of the line can be reduced.

In the present embodiment, the thickness of a part of a first line 41 corresponding to the first line 11 according to Embodiment 1 is reduced. Alternatively, the thickness of a part of a second line can be reduced. Alternatively, the thicknesses of the lines of the Marchand baluns according to Embodiment 2 and Embodiment 3 can be reduced, similarly to Embodiment 4.

### Embodiment 5

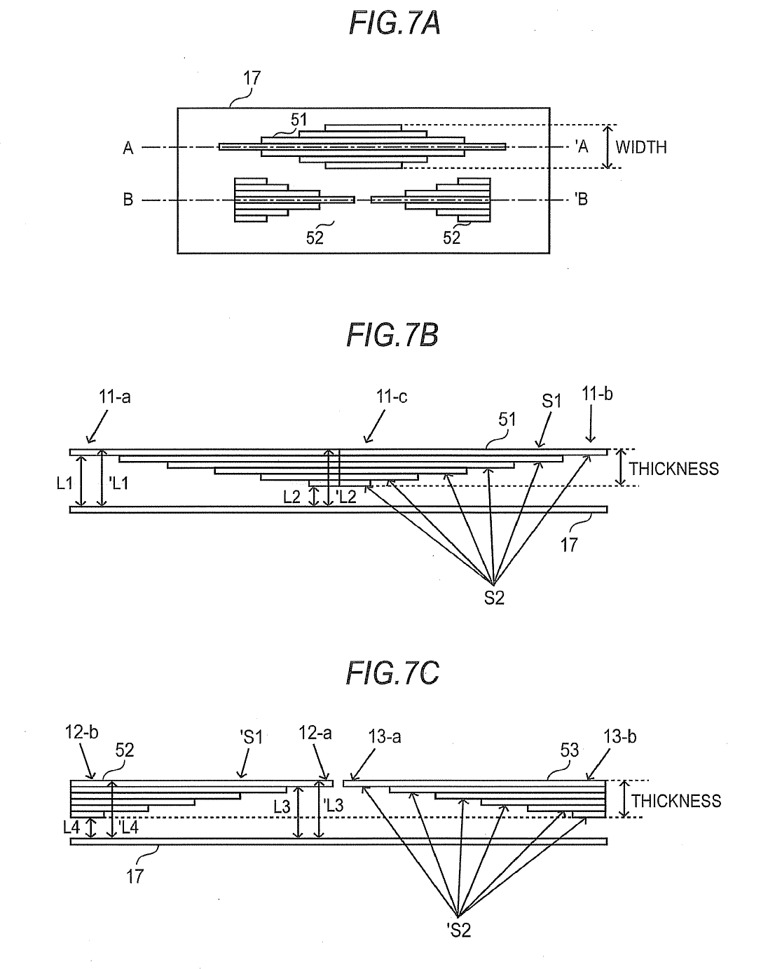

A Marchand balun according to Embodiment 5 is described hereinafter with reference to FIGS. 7A to 7C. The Marchand balun according to Embodiment 5 employs the same configuration and the same operating principle as those of the Marchand balun according to Embodiment 1, except for the width of each of the lines. Thus, components of Embodiment 5, which are the same as those of Embodiment 1, are designated with the same reference numerals as those denoting the same components of Embodiment 1. Consequently, the description of such components is omitted.

A first line 51 has a structure tapered not only in a thickness direction but also in a width direction. That is, the width of a center 11-c is larger than those of ends 11-a and 11-b. This can be implemented by arranging a plurality of line-members in line in the width direction. At that time, a first line 51 is configured by arranging the plurality of line-members, which differ in length from one another, in the descending order of length in the width direction from the innermost one to the outermost one. Thus, the first line 51 is constructed, in which the width of the center 11-c is largest.

Further, each of the second line 52 and the third line 53 has a structure tapered in the width direction. That is, as compared with the widths of one ends 12-a and 13-a, the widths of the other ends 12-b and 13-b have a larger width. This structure can be implemented by arranging a plurality of line-members, which differ in length from one another, in line in the width direction. At that time, each of the second line 52 and the third line 53, in each of which the width of an associated one of the other ends 12-b and 13-b is largest, can be implemented by arranging the plurality of line-members in the width direction from the innermost one to the outermost one in the descending direction of length.

As described above, according to Embodiment 5, each of the lines of the Marchand balun has a structure tapered not only in the thickness direction but also in the width direction. Thus, according to Embodiment 5, the cross-sectional area of the center 11-c, or the other ends 12-b and 13-b, in which a large current flows, can be set to be larger than that of an associated portion of Embodiment 1. Further, the cross-sectional area of the ends 11-a, 11-b, or the one end 12-a, 13-a, in which current is hard to flow, can be set to be smaller than that of an associated portion of Embodiment 1. Accordingly, unnecessary loss caused in the line can be more effectively suppressed. Thus, the passage loss of the Marchand balun can be more effectively reduced.

Although the width-direction tapered-structure is illustrated based on the Marchand balun according to Embodiment 1, similar advantages can be obtained by providing a Marchand balun according to another embodiment with the lines each of which is tapered in the width direction.

### Embodiment 6

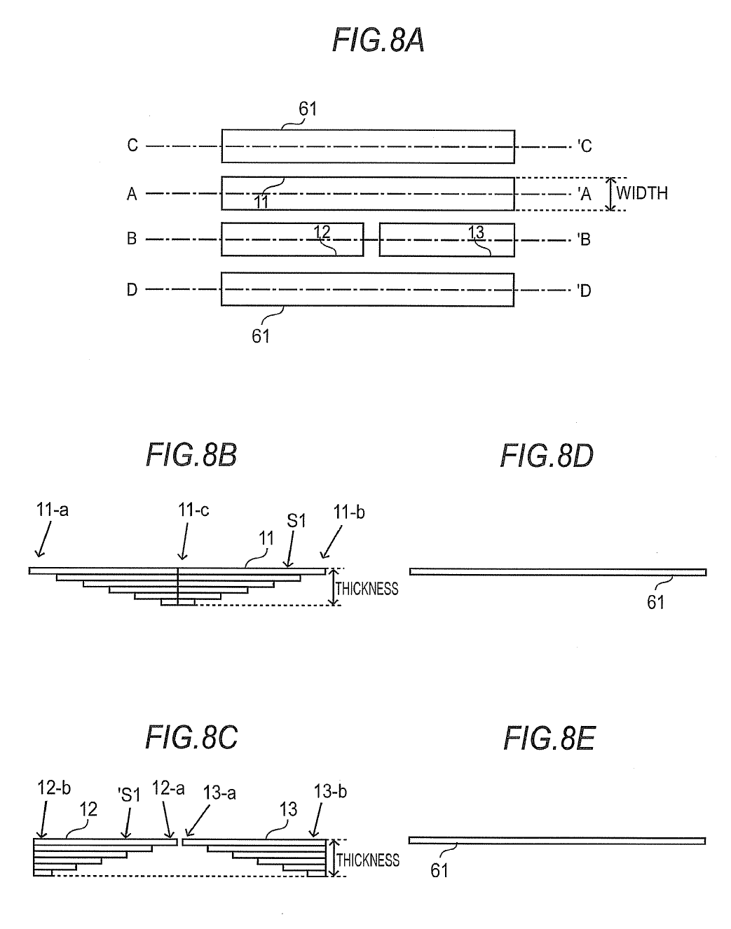

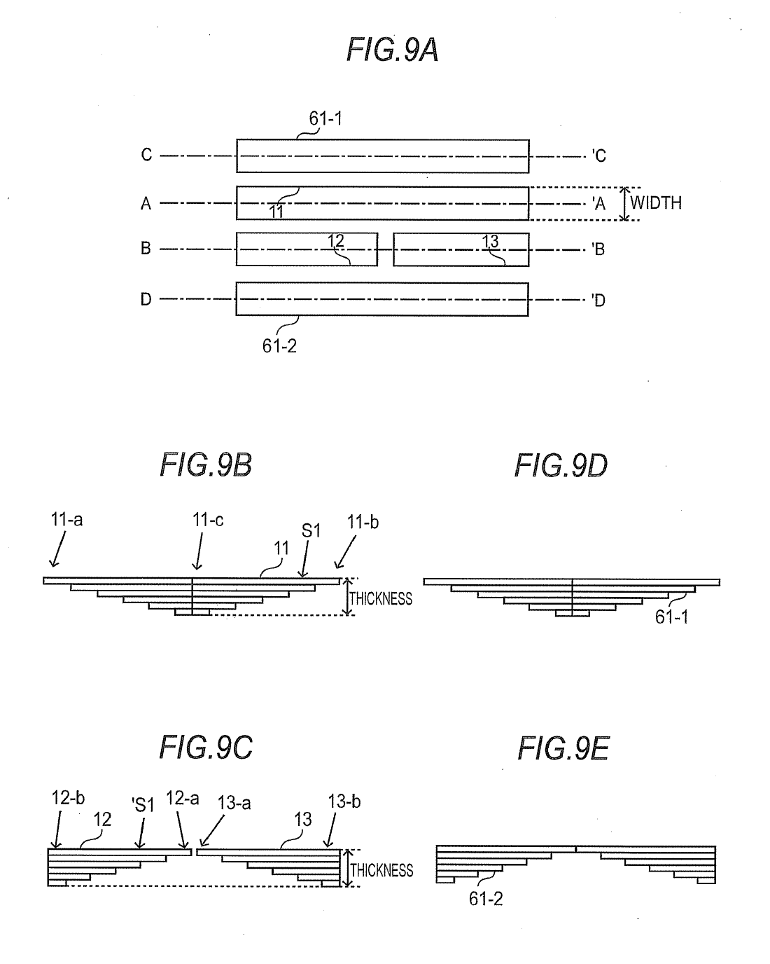

A Marchand balun according to Embodiment 6 is described hereinafter with reference to FIGS. 8A to 8E and 9A to 9E. The Marchand balun according to Embodiment 6 employs the same configuration and the same operating principle as those of the Marchand balun according to Embodiment 1, except for the position of the ground. Thus, components of Embodiment 6, which are the same as those of Embodiment 1, are designated with the same reference numerals as those denoting the same components of Embodiment 1. Consequently, the description of such components is omitted.

FIGS. 8A and 9A are top diagrams of the Marchand baluns according to Embodiment 6, respectively. FIG. 8B is a cross-sectional diagram of the Marchand balun according to the present embodiment, which is taken on line A-′A shown in FIG. 8A. FIG. 8C is a cross-sectional diagram of the Marchand balun according to the present embodiment, which is taken on line B-′B shown in FIG. 8A. FIG. 8D is a cross-sectional diagram of the Marchand balun according to the present embodiment, which is taken on line C-′C shown in FIG. 8A. FIG. 8E is a cross-sectional diagram of the Marchand balun according to the present embodiment, which is taken on line D-′D shown in FIG. 8A.

FIG. 9B is a cross-sectional diagram of the Marchand balun according to the present embodiment, which is taken on line A-′A shown in FIG. 9A. FIG. 9C is a cross-sectional diagram of the Marchand balun according to the present embodiment, which is taken on line B-′B shown in FIG. 9A. FIG. 9D is a cross-sectional diagram of the Marchand balun according to the present embodiment, which is taken on line C-′C shown in FIG. 9A. FIG. 9E is a cross-sectional diagram of the Marchand balun according to the present embodiment, which is taken on line D-′D shown in FIG. 9A.

In the Marchand balun illustrated in FIGS. 2B and 2C, the ground 17 is provided under the first line 11, the second line 12, and the third line 13. That is, in the Marchand balun illustrated in FIGS. 2B and 2C, the ground 17, the first line 11, the second line 12, and the third line 13 are stacked in the width direction.

On the other hand, in the Marchand balun according to the present embodiment, a ground 61 is placed beside the first line 11, and beside the second line 12 and the third line 13, as illustrated in FIG. 8A. That is, the ground 61 and each of the lines 11 to 13 are placed on the same plane.

As illustrated in FIGS. 8D and 8E, the ground 61 is not provided with a part tapered in the thickness direction. When each of the lines 11 to 13 includes a plurality of line-members differing in length from one another, the ground 61 is placed on the same plane on which the longest line-member.

Alternatively, as illustrated in FIGS. 9D and 9E, the ground 61 can have a part tapered in the thickness direction. In this case, a ground 61-1 arranged close to the first line 11 is provided with a tapered part similar to the tapered part of the first line 11. That is, the thickness of a portion of a ground 61-1, which is closest to the center 11-c of the first line 11, is largest, while the thickness of a portion of the ground 61-1, which is closest to each of the ends 11-a and 11-b, is smallest.

On the other hand, a ground 61-2 arranged close to the second line 12 and the third line 13 is provided with tapered portions which are similar to the tapered portions of the second line 12 and the third line 13, respectively. That is, the thickness of a portion of the ground 61-2, which is closest to each of one end 12-a of the second line 12 and one end 13-a of the third line 13, is smallest. The thickness of a portion of the ground 61-2, which is closest to each of the other end 12-b of the second line 12 and the other end 13-b of the third line 13, is smallest.

Even in the case of changing the arrangement of the ground 61 in the aforementioned manner, advantages similar to those of Embodiment 1 can be obtained. In addition, variation in the characteristic impedance depending upon a position in the Marchand balun can be reduced. That is, the present embodiment can provide a Marchand balun, the variation of the characteristic impedance of which is small.

Additionally, the ground 61 can be provided with a part tapered in the thickness direction. Consequently, the passage loss of the Marchand balun can be reduced still more. This is because a ground current to be paired with a signal current flows in the ground 61 when the signal current flows in each of the lines 11 to 13. The Marchand balun illustrated in FIGS. 9A to 9E has a structure in which the cross-sectional area of a ground metal is increased at a part in which a large ground current flows. Accordingly, the passage loss of the Marchand balun can be reduced still more.

The arrangement of the ground is not limited to that described in the foregoing description of the aforementioned embodiments. As long as the position of the ground is placed close to the signal flowing in each of the lines, the ground can be placed at a given position.

Additionally, the invention is not limited to the aforementioned embodiments as they are. The invention can be embodied by changing components thereof without departing from the gist thereof in an implementation stage. Further, various modifications of the invention can be made by appropriately combining a plurality of components disclosed in the foregoing description of the embodiments. For example, several components can be deleted from all the components described in the embodiment. Moreover, components of different embodiments can appropriately be combined with one another.

According to an aspect of the present invention, there is provided a Marchand balun of the low passage loss.

What is claimed is:

1. A Marchand balun for converting a single-mode signal into a differential-mode signal or for converting the differential-mode signal into the single-mode signal, the Marchand balun comprising:
a first line including:
a first end portion configured to input or output the single-mode signal;
a second end portion electrically opened; and
a central portion, the first line having a length substantially equal to one half of a wavelength corresponding to an operating frequency; and
a second line and a third line each including:
a third end portion configured to input or output the differential-mode signal; and
a fourth end portion connected to a ground, the second and third lines each having a length substantially equal to one quarter of the wavelength corresponding to the operating frequency,
wherein the second and third lines are arranged to be substantially parallel to the first line and are arranged so that the third end portions are closely faces via a gap,
wherein a thickness of the first line at the central portion is thicker than those at the first and second end portions, and
wherein thicknesses of the second and third lines at the fourth end portions are thicker than those at the third end portions.

2. The Marchand balun of claim 1,
wherein the first to third lines each includes:
a first surface that is away from the ground; and
a second surface that is facing toward the ground,
wherein a distance between the second surface at the central portion and the ground is smaller than a distance between the second surface at the first and second end portions and the ground, and
wherein distances between the second surfaces at the third end portion and the ground is smaller than distances between the second surfaces at the fourth end portions and the ground.

3. The Marchand balun of claim 2,
wherein distances between the first surfaces and the ground are substantially constant.

4. The Marchand balun of claim 1,
wherein the first to third lines each includes:
a first surface that is away from the ground; and
a second surface that is facing toward the ground, wherein a distance between the first surface at the central portion and the ground is larger than a distance between the first surface at the first and second end portions and the ground, and
wherein distances between the first surfaces at the third end portion and the ground is smaller than distances between the first surfaces at the fourth end portions and the ground.

5. The Marchand balun of claim 4,
wherein distances between the second surfaces and the ground are substantially constant.

6. The Marchand balun of claim 1,
wherein the first to third lines are each formed of a plurality of line-members that are stacked in a thickness direction and that differ in length from one another.

7. The Marchand balun of claim 1,
wherein the thickness of the first line gradually increases from the first and second end portions toward the central portion, and
wherein the thicknesses of the second and third lines gradually increase from the third end portions toward the fourth end portions.

8. The Marchand balun of claim 1,
wherein a width of the first line at the central portion is larger than the width of the first line at the first and second end portions, and
wherein widths of the second and third lines at the fourth end portions are larger than the widths of the second and third lines at the third end portions.

9. The Marchand balun of claim 8,
wherein the first to third lines are each formed of a plurality of line-members that are stacked in a thickness direction and that differ in length from one another.

10. The Marchand balun of claim 8,
wherein the width of the first line gradually increases from the first and second end portions toward the central portion, and
wherein the widths of the second and third lines gradually increase from the third end portions toward the fourth end portions.

11. The Marchand balun of claim 1,
wherein the ground includes:
a first ground that is disposed in a neighbor of the first line; and
a second ground that is disposed in a neighbor of the second and third lines,
wherein a thickness of the first ground gradually increases from both end portions thereof toward a central portion thereof, and
wherein a thickness of the second ground gradually decreases from both end portions thereof toward a central portion thereof.
